(19) United States
(12) Patent Application Publication
(10) Pub. No.: US 2007/0232710 A1
(43) Pub. Date: Oct. 4, 2007

(54) Sound absorbing article, method of producing the same, and method of recycling the same

(75) Inventors: Kentaro Yoshida, Yokohama-shi (JP); Yumiko Oyasato, Yokohama-shi (JP); Akiko Suzuki, Tokyo (JP)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 11/717,962

(22) Filed: Mar. 14, 2007

(30) Foreign Application Priority Data
Mar. 29, 2006 (JP) 2006-090595

(51) Int. Cl. C08J 9/00

(52) U.S. Cl. 521/84.1

(57) ABSTRACT

A sound absorbing article has a water-soluble foamed matrix including a water-soluble polymer and an ionic surfactant, in which an open cell is formed in the foamed matrix.

### CROSS-REFERENCE TO RELATED APPLICATIONS

This application is based upon and claims the benefit of priority from prior Japanese Patent Application No. 2006-090595, filed Mar. 29, 2006, the entire contents of which are incorporated herein by reference.

### BACKGROUND OF THE INVENTION

1. Field of the Invention

The present invention relates to a sound absorbing article having a water-soluble foamed matrix, a method of producing the same, and a method of recycling the same.

2. Description of the Related Art

Conventionally, sound absorbing articles use porous materials made of organic polymer derived from petroleum (see JP-B 3,403,417). However, the conventional sound absorbing articles made of organic polymer porous materials are insufficient in sound absorbing performance and also have disadvantages in terms of harmfulness of raw materials, harmfulness of combustion products and difficulty in recycling. Thus, necessity of alternative sound absorbing articles has been pointed out.

The sound absorbing articles exhibit sound absorbing performance through a mechanism that vibrational energy applied to cells in the article is converted into heat energy. In order to ensure sufficient sound absorbing performance for conventional organic polymer porous materials, it is necessary to increase a specific surface area per unit weight and thereby to increase contact surface area with air by increasing the thickness of the article itself, the thickness of fiber diameter, the fiber length or the fiber density. Therefore, high-performance sound absorbing articles become thick and bulky, and thus they cannot be used in such applications that there is a limit in thickness or space, such as sliding screen paper, wall paper, casings and covers for electrical appliances.

On the other hand, in view of conservation of natural environment, biodegradable resins and their formed products and foamed products decomposable in natural environments have been demanded. For example, studies on biodegradable resins made from aliphatic polyesters, starch, or chemically modified substances thereof have been actively made. However, these biodegradable resins cannot exhibit a sound absorbing property and no application of these biodegradable resins to sound absorbing articles has been made possible.

Meanwhile, naturally-occurring water-soluble polysaccharides or water-soluble proteins of the water-soluble polymers, in particular, have high safety and can be decomposed quickly by microorganism when discarded to natural environments. Those that have gel-forming ability of these materials have been widely used for tackifiers and gelling agents in fields of food, cosmetics and toiletry. Further, since these materials have formability, they have been used as edible films such as cachet. However, formed products made of these materials are inferior in strength and cannot be used for structural materials such as sound absorbing articles.

Alginic acid of the naturally-occurring water-soluble polysaccharides or water-soluble proteins, for example, can be obtained from unnecessary seaweeds which cause no food problem and has potential to suppress costs to the minimum. Owing to water-solubility, the alginic acid is highly promising as a future resin material with a low environmental load. Thus, it has been attempted to produce biodegradable polymers using the alginic acid (see JP-A 8-337674 (KOKAI)). These biodegradable polymers are prepared by mixing alginic acid or its metal salt with a foaming agent, a plasticizer, a crosslinking agent and so forth, and have a water retention property. However, these biodegradable polymers have a hard surface and no compressive property, and thus are not suitable for structural materials such as sound absorbing articles.

### BRIEF SUMMARY OF THE INVENTION

According to one aspect of the present invention, there is provided a sound absorbing article, comprising: a water-soluble foamed matrix comprising a water-soluble polymer and an ionic surfactant, wherein an open cell is formed in the foamed matrix.

According to another aspect of the present invention, there is provided a method of producing a sound absorbing article, comprising: preparing an aqueous solution comprising a water-soluble polymer and an ionic surfactant; foaming the aqueous solution to provide a foamed composition; freezing the foamed composition to form a foamed frozen product; and drying the foamed frozen product to produce a sound absorbing article.

### BRIEF DESCRIPTION OF THE SEVERAL VIEWS OF THE DRAWING

FIG. 1 is a micrograph of a cross section of a sound absorbing article according to an embodiment; and

FIG. 2 is a graph showing the relationship between the frequency and the sound absorption coefficient of sound absorbing articles in Examples 1 to 6 and Comparative Examples 1 and 2.

### DETAILED DESCRIPTION OF THE INVENTION

Embodiments of the present invention will be described below.

The present inventors have made various studies on sound absorbing articles produced with water-soluble polymers. Consequently, they have found that, if a sound absorbing article has a water-soluble foamed matrix comprising a water-soluble polymer and an ionic surfactant and contains continuous layered open cells resulting from breakage of cell walls in the foamed matrix, the article has excellent sound absorbing performance as compared with conventional ones in a frequency region important for home electric appliances.

Hereinafter, a structure of a sound absorbing article, a mechanism of improving the sound-absorbing performance, a water-soluble polymer material, an ionic surfactant, a method of producing a sound absorbing article, and a method of recycling a sound absorbing article will be described.

(Structure of Sound Absorbing Article)

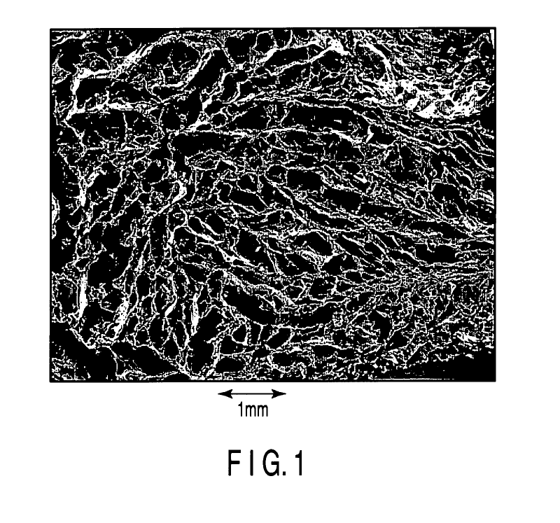

FIG. 1 shows a micrograph of a cross section of a sound absorbing article according to an embodiment. As shown in FIG. 1, the sound absorbing article according to the embodiment contains layered open cells which are formed as a result of breakage of the walls of closed cells in the foamed matrix. If the sound absorbing article contains open cells as described above, characteristics thereof are not so much varied. However, the minimum diameter of the cells is preferably 0.10 mm or more and 0.35 mm or less. If the minimum diameter of the cells is smaller than the above range, the article disadvantageously has high rigidity and poor flexibility. On the other hand, if the minimum diameter of the cells exceeds the above range, which implies increased coarse cells, the article disadvantageously has low rigidity.

It is preferable that each cell has flat shape with a ratio (b/a) of the maximum diameter (b) to the minimum diameter (a) of three or more and that the volume of these flat cells accounts for 80% of total volume of all cells. If the ratio of maximum diameter to the minimum diameter of the cells is smaller than the above range, there is possibility that the article may have high rigidity and poor flexibility. If the volume of the flat cells is lower than 80% of the total volume of all cells, there is possibility that the article may have high rigidity and poor flexibility.

(Mechanism of Improving Sound-Absorbing Performance)

The sound absorbing article according to the embodiment exhibits improved sound-absorbing performance because of presence of an ionic surfactant as a foreign substance in the foamed matrix. In the sound absorbing article, the sound absorbing performance is exhibited through the mechanism that vibrational energy applied to cells in the article is converted into heat energy. In addition, it is assumed that, in the sound absorbing article of the embodiment, the ionic surfactant tends to cause electric vibration. It is supposed that, owing to these actions, friction between the water-soluble polymer and the surfactant molecule or friction between the surfactant molecules is promoted, which makes easy the conversion of the vibration energy to the heat energy. The sound absorbing article of the embodiment is supposed to have improved sound absorbing performance due to such mechanism.

(Water-Soluble Polymer)

Examples of the water-soluble polymer used for the sound absorbing article of the embodiment are as follows. That is, the examples include alginic acid, hyaluronic acid, cargeenan, agar, xanthan gum, gellan gum, locust bean gum, guar gum, gum arabic, gum ghatti, pectin, chitosan, mannan, cellulose, dextrin, glycogen, starch, amylose, amylopectin, glue, carboxymethyl cellulose, hydroxyethyl cellulose, hydroxypropyl cellulose, carboxymethyl dextran, carboxymethyl pullulan, and their metal salts and their physiologically acceptable artificial derivatives; chitin derivatives such as carboxylmethyl chitin; gelatin, albumin, protamine, lecithin, casein, egg white protein, egg yellow protein, rice protein, wheat protein, soybean protein, and their metal salts and their physiologically acceptable artificial derivatives; synthetic water-soluble polymer materials such as polyvinyl alcohol, polyethylene glycol, carboxymethyl cellulose, methyl cellulose, and their metal salts and their physiologically acceptable artificial derivatives.

Particularly, in the case where alginic acid, an alginic acid salt or an alginic acid derivative is used as the water-soluble polymer, the polymer can retain mechanical characteristics without exhibiting coagulation property even if the polymer is subjected to heating treatment. In addition, since the particular water-soluble polymer serves to reduce additives such as a coagulant, the polymer can be easily processed in recycling or in disposal.

The weight-average molecular weight of the water-soluble polymer can be determined properly depending on the type of the polymer. For example, in the case of alginic acid and a derivative thereof, the weight-average molecular weight is preferably ranging from 70,000 to 100,000, which corresponds to a polymerization degree of 299 to 427. In the case of hyaluronic acid and a derivative thereof, the weight-average molecular weight is preferably ranging from 100,000 to 150,000, which corresponds to a polymerization degree of 220 to 331. In the case of starch, the weight-average molecular weight is preferably ranging from 100,000 to 1,000,000, which corresponds to a polymerization degree of 617 to 6,173. In general, as the weight-average molecular weight of water-soluble polysaccharides or water-soluble proteins increases, it tends to have increased viscosity and it becomes hard to be dissolved, and it becomes hard to be processed into a sound absorbing article. Therefore, it is preferable to limit the upper weight-average molecular weight to approximately 1,000,000.

In the embodiments, these water-soluble polymers may be used alone or in a mixture of two or more types. Use of a mixture of two or more types of water-soluble polymers may improve sound-absorbing characteristics, mechanical characteristics, and apparent density of the sound absorbing article. Here, the water-soluble polymers exhibit different characteristics as a sound absorbing article depending on the water solubility, linearity, and gelling property. Accordingly, use of a mixture of two or more types of water-soluble polymers which complement disadvantages of the respective polymers may improve characteristics such as sound-absorbing performance, mechanical characteristics, expansion ratio, and water solubility. For example, it is preferable to select two or more types of water-soluble polymers with different apparent densities, that is, densities in a form of a film.

(Ionic Surfactant)

In the sound absorbing article of the embodiment, the ionic surfactant is added to improve foaming property, to stabilize produced foams, and to improve sound-absorbing performance of the sound absorbing article. The ionic surfactant can be classified into cationic, anionic and amphoteric surfactants, and other types.

Examples of the cationic surfactant include alkyltrimethylammonium salts (e.g., alkyltrimethylammonium chloride), dialkyldimethylammonium salts (e.g., dialkyldimethylammonium chloride), benzalconium chloride salts, alkylpyridinium chlorides, alkyldimethylbenzylammonium salts, N-methylbishydroxyethylamine fatty acid ester hydrochlorides, imidazoline monocarboxylate compounds, and imidazoline dicarboxylate compounds.

Examples of the anionic surfactant include fatty acid salts (e.g., sodium stearate, soap produced from natural beef tallow, coconut oil or palm oil, and rosin soap), alkylsulfates (AS; e.g., sodium dodecylsulfate), polyoxyethylene alkyl ether acetates, monoalkylphosphates, α-sulfofatty acid ester salts (α-SFE), alkylbenzenesulfonates (ABS), [e.g., linear alkyl benzenesulfonates (LAS) having a linear hydrocarbon group as a hydrophobic group], α-olefin sulfonates (AOS), other sulfonates (e.g., sulfosuccinate), alkyl ether sulfates (AES), alkylsulfate triethanolamine, alkyl ether carboxylates, dialkylsulfosuccinates, naphthalenesulfonates and their formaldehyde condensates, alkanesulfonates (SAS), higher alcohol or monoalkyl (MAP) phosphates and their ethylene oxide adducts, and acyl-N-methyltaurine salts.

Examples of the amphoteric surfactant include alkyl dimethylamino acetic betaine, alkyl dimethylamine oxide, alkyl carboxymethylhydroxyethylimidazolium betaine, alkyl amidopropyl betaine, alkylamino fatty acid salts (e.g., N-alkyl-β-alanine), alkylamine oxides, and alkyl carboxy betaine.

Examples of other ionic surfactants include phospholipid (e.g., lecithin) and saponin type compounds widely distributed in the plant world.

The ionic surfactant may be selected properly in view or water solubility, safety and biodegradability and should not be limited to those exemplified above.

The addition amount of the ionic surfactant is generally about 1 to 10% by weight with respect to 100% by weight of the foamed composition. If the addition amount is lower than 1% by weight, it becomes difficult to obtain a sufficient effect of the ionic surfactant. On the other hand, if it exceeds 10% by weight, the sound-absorbing performance, mechanical characteristics, and environment-friendliness of the sound absorbing article may be degraded.

The ionic surfactant is preferably pulverized into particles in a form of a sphere, elliptical sphere, or chip. The particle size of the ionic surfactant is advantageously about 1 μm to 1 mm, more preferably 0.1 mm or more and 0.7 mm or less at the maximum length.

(Other Components)

The foamed composition of the embodiment may contain a plasticizer to optimize mechanical characteristics of the sound absorbing article. The plasticizer serves to reduce shrinkage in fan drying during production of the sound absorbing article and to provide flexibility to the sound absorbing article after foaming. Examples of the plasticizer include glycerol, glucose, polyhydric alcohol, triethanolamine, stearates, diglycerin, triglycerin, pentaglycerin, and decaglycerin. The plasticizer may be selected properly in view of water solubility, safety and biodegradability and should not be limited to those exemplified above.

The addition amount of the plasticizer is generally about 10 to 30% by weight, preferably about 15 to 25% by weight with respect to 100% by weight of the foamed composition. If the addition amount is less than 10% by weight, it becomes difficult to obtain a sufficient effect of the plasticizer. On the other hand, if the addition amount exceeds 30% by weight, mechanical characteristics and environment-friendliness of the sound absorbing article may be degraded.

The foamed composition of the embodiment may contain, if necessary, a oligomeric or polymeric foam modifying agent. The foam modifying agent serves to improve flexibility and toughness of the sound absorbing article. Examples of the foam modifying agent include polyethylene glycol, polyacrylamide, polyacrylic acid, polyvinyl alcohol, polyvinylpyrrolidone, polyoxazoline, and polyethyleneimine.

If the foam modifying agent is added at a ratio of about 1% by weight with respect to 100% by weight of the foamed composition, the above effect can be obtained. However, in the case where an excess amount of the foam modifying agent is added, mechanical characteristics and environment-friendliness of the sound absorbing article may be degraded. Therefore, the addition amount is preferably set to about 3% by weight or less with respect to 100% by weight of the foamed composition.

The foamed composition of the embodiment may contain, if necessary, a foam stabilizing agent to improve the heat stability of the sound absorbing article. Examples of the foam stabilizing agent include ammonium stearate, dodecyl alcohol, tetaradecanol, hexadecanol, tridecyloxypolyethanol, and polyoxyethylated oleylamine. The addition amount of the foam stabilizing agent is not particularly limited, but generally if the foam stabilizing agent is added at a ratio of about 1% by weight with respect to 100% by weight of the foamed composition, the above effect can sufficiently be obtained. However, in the case where an excess amount of the foam stabilizing agent is added, mechanical characteristics and environment-friendliness of the sound absorbing article may be degraded. Therefore, the addition amount is preferably set to about 3% by weight or less.

(Production of Sound Absorbing Article)

The sound absorbing article of the embodiment can be produced as follows.

First, the aforementioned water-soluble polymer and ionic surfactant are dissolved in water to prepare an aqueous solution with a proper viscosity. The aqueous solution is foamed by mechanical agitation to obtain a foamed composition. The mechanical agitation may be carried out with a pressure mixer, a continuous high-pressure foaming mixer, a kitchen mixer, a beater, or a homogenizer.

At the mechanical agitation, the viscosity of the aqueous solution considerably affects the foaming state and properties. Therefore, the viscosity of the aqueous solution is preferably set to 1.0×10¹ (Pa·s) or more and 1.5×10⁷ (Pa·s) or less. If the viscosity of the aqueous solution is lower than 1.0×10¹ (Pa·s), a film in a foamed state tends to be broken. On the other hand, if the viscosity of the aqueous solution exceeds 1.5×10⁷ (Pa·s), it becomes difficult to ensure a proper expansion ratio and good cushioning characteristics of the sound absorbing article. The viscosity of the aqueous solution is determined in accordance with the type, polymerization degree, weight-average molecular weight, and amount of the water-soluble polymer. Accordingly, it is preferable to adjust the amount in accordance with the type of the water-soluble polymer so as to obtain the viscosity in the aforementioned range. If the viscosity is in the aforementioned range, the aqueous solution is easy to be processed and also the sound absorbing article has high durability.

Next, the resultant foamed composition in a wet state is cast in a desired mold to form the composition into a sheet or plate. The thickness of the formed product may be selected optionally in a range of about 1 mm or more to about 50 mm or less depending on use. The formed product contains layered open cells created by breakage of cells inside thereof. The “breakage of cells” means a phenomenon that the cells are coarsened or partially defected due to external factors such as shear stress and cutting. If closed cells exist in a large quantity inside the formed product, the walls of the cells become thick or the composition may become ununiform, which leads disadvantageously to lowered mechanical characteristics in heating. On the other hand, the cells present in the surface area of the formed product are not so considerably broken and have approximately equal cell diameters and cell diameter distribution. By retaining this structure of the formed product, it is possible to obtain a sound absorbing article containing open cells and having a layered structure of foamed matrix as shown in FIG. 1.

After the cast molding, the formed product is subjected to drying treatment by freeze drying to lower the water content to 10% or less by which a sound absorbing article with a desired fine cell structure can be produced. The drying treatment is preferably carried out at a room temperature (25° C.) for about two days or at a temperature equal to or lower than the melting point of water and under a pressure close to vacuum for a day. If the drying treatment is insufficient, water is evaporated or leaks during use and may result in inconvenient consequence, for example, may cause an adverse effect on a substance vulnerable to water. In terms of retention of good formability without degrading the characteristics of the sound absorbing article, it is particularly preferable to carry out the drying at a temperature around 10° C. and under a pressure of 10 Pa or less, but the drying conditions are is not limited to those in the above method. Convection drying at room temperature may be carried out using an apparatus (e.g., a table top ventilator and a local exhauster) capable of blowing air to an enclosed space.

The sound absorbing article thus produced has water-soluble foamed matrix comprising the water-soluble polymer and the ionic surfactant and contains open cells in the foamed matrix. The resultant sound absorbing article may be cut into a piece with a prescribed size which can be applied as it is to parts such as electronic appliances that are scarcely brought into contact with water or humidity. A plurality of sheets of the sound absorbing article may be used in a laminated form. In this case, at least two sheets are laminated and mechanically or chemically bonded. Specifically, the sheets are laminated into the composite structure by adhering the sheets using two-component epoxy-based adhesive, rubber-based adhesive, cyanoacrylate-based adhesive, vinyl acetate resin emulsion or starch glue, or by adhering the sheets with a resin film interposed therebetween, the resin film being that coated with a hot melt adhesive, a polyimide-based adhesive film or an ethylene-acrylate copolymer-based adhesive film. Such a laminated sheet can also be applied to parts such as electronic appliances that are scarcely brought into contact with water or humidity.

(Use of Sound Absorbing Article)

The sound absorbing article according to the embodiment can be used as an article constituting an audio instrument such as a speaker and a microphone and an article used for various acoustic treatments in fields of architectural acoustics and countermeasure to noise issue, aiming at sound absorption and resonance prevention. Further, the sound absorbing article can be processed into a piece with an arbitrary shape, which is expected to be used for toys, DIY materials, sheets, furniture parts, construction materials for building and civil engineering, transportation vehicles such as automobiles and trains, home electric appliances, parts for OA appliances, power generation apparatuses, transformers, compressors, interior materials and housings.

(Evaluation of Sound Absorbing Article)

The sound absorbing performance herein is evaluated by measuring a normal incident sound absorption coefficient (standing-wave method) according to JIS A 1405. As an alternative method for evaluating sound-absorbing performance, there is known a method for measurement for sound absorption coefficient in a reverberation room (JIS A1409). It is expected that the latter method also gives same results as the former method. The sound absorption coefficient of the sound absorbing article is measured at various frequencies in a state without air layer at the back, that is, in a state that the article is in contact with a rigid wall. The sound absorbing performance is better as the sound absorption coefficient is higher at a prescribed frequency. Note that the JIS A 1405 standard covers a range up to 5,000 Hz. In view of applications to a region where a frequency emitted from electric appliances particularly exists, however, the sound absorption coefficient is measured in a range up to 10,000 Hz.

(Recycling of Sound Absorbing Article)

The sound absorbing article of the embodiment may be degraded with time during use so as to have lowered function. In such a case, the sound absorbing article can be recycled by the recycling method according to an embodiment. Since the sound absorbing article according to the embodiment contains the water-soluble polymer, it can be easily treated with water after use. That is, the sound absorbing article can be recycled by a method comprising: dissolving the sound absorbing article in water to prepare an aqueous solution; foaming the aqueous solution to provide a foamed composition; freezing the foamed composition to form a foamed frozen product; and drying the foamed frozen product to produce a recycled sound absorbing article.

An aqueous solution of the sound absorbing article can be prepared by immersing the article in water and stirring the water with a stirrer equipped with stirring blades. In dissolving the sound absorbing article, a stirrer with a heating function (a hot stirrer), for example, may be used to heat the solution up to about 60° C. Accordingly, dissolution of the sound absorbing article can be promoted. However, when the solution is heated to excessively high temperatures, the water-soluble polymer contained in the sound absorbing article may experience decrease in the molecular weight, disadvantageously leading to degraded mechanical properties of the recycled sound absorbing article. In order to avoid this drawback, it is preferable to limit the upper heating temperature to around 80° C. Since the sound absorbing article according to the embodiment can easily be dissolved within several minutes to one hour regardless of the concentration thereof, it does not take any trouble for dissolution in recycling.

In dissolving the sound absorbing article in water, a new resin (a virgin resin) may be added for repairing degradation of the resin. The addition amount of the virgin resin differs depending on duration of service. In general, the addition of the virgin resin at a ratio of about 50 to 150% with respect to the resin to be recycled may recover durability of the virgin article.

It is desirable to adjust the water amount so as to control the viscosity of the aqueous solution, prepared by dissolving the sound absorbing article in water, to a prescribed range. Specifically, the viscosity of the aqueous solution is preferably in the range of 1.0×10¹ (Pa·s) or more to 1.5×10⁷ (Pa·s) or less. As already described, since the viscosity of the aqueous solution in foaming considerably affects the state of the cells and properties of the sound absorbing article, it is desirable to control the viscosity of the aqueous solution.

The sound absorbing article dissolved in water can be transported in a larger quantity than a conventional sound absorbing article, which brings about advantages for recycling and disposal of the sound absorbing article. In the case where a conventional sound absorbing article is transported as it is, the quantity of the article may be only 15% of the maximum load capacity of a vehicle. To the contrary, the sound absorbing article of the embodiment can be dissolved in water at a water-soluble polymer concentration of 15% by weight or more. If the viscosity of the aqueous solution can be controlled in a range of 1.0×10¹ (Pa·s) or more to 1.5×10⁷ (Pa·s) or less in transport, the solution can be immediately foamed to recycle the sound absorbing article. In the case where the viscosity cannot be controlled in the desired range in transport, in may be controlled by mixing a virgin resin or by adjusting the amount of water just before foaming.

Next, the resultant aqueous solution is mechanically agitated to provide a foamed composition. The resultant foamed composition in a wet state is cast in a desired mold and formed into a sheet or plate. After the cast molding, the formed product is subjected to drying treatment by freeze drying to lower the water content to 10% or less by which a sound absorbing article with a desired fine cell structure can be recycled.

Since the sound absorbing article recycled by the recycling method according the embodiment has characteristics comparable to those of the sound absorbing article before use (the virgin sound absorbing article), the recycled article can be used for various uses similarly to the virgin sound absorbing article. That is, the recycled sound absorbing article may be cut into a piece with a prescribed size which can be applied as it is to parts such as electronic appliances that are scarcely brought into contact with water or humidity. A plurality of sheets of the recycled sound absorbing article may be used in a laminated form. In this case, at least two sheets are laminated and mechanically or chemically adhered.

As described above, since the sound absorbing article according to the embodiment contains the water-soluble polymer and the ionic surfactant, a load on environment can be lowered to the minimum even when it is discarded. Moreover, the sound absorbing article according to the embodiment exhibits good sound absorbing performance and mechanical characteristics. Further, since the sound absorbing article according to the embodiment is water-soluble, it can be easily recycled. The recycled sound absorbing article has good sound-absorbing performance and mechanical characteristics similar to those of the virgin article and can be reused.

### EXAMPLES

Hereinafter, the present invention will be described based on Examples.

In the following Examples and Comparative Examples, produced sound absorbing articles were evaluated for the following properties.

(1) Sound Absorption Coefficient

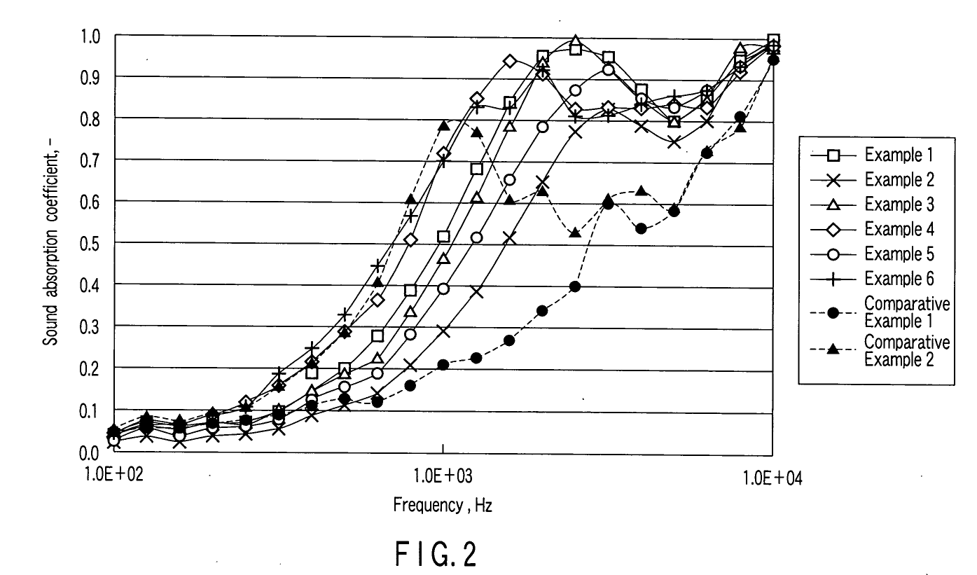

The normal incident sound absorption coefficient was measured in the range of 100 to 10,000 Hz by an impedance tube method (JIS A 1405). The normal incident sound absorption coefficient was determined by carrying out measurements for three samples for each Example under the same conditions and calculating the average. FIG. 2 shows the relationship between the frequency and the sound absorption coefficient.

(2) Water Dissolution Time

The sound absorbing article is immersed in water in an amount of 20 times as much (concentration 5% by weight) at room temperature, and the time required for the article to be completely dissolved (water dissolution time) was examined. If the water dissolution time is within 60 minutes, it can be judged that the sound absorbing article has sufficient water solubility.

### Example 1

Propylene glycol alginate (available from KIMIKA corporation, KIMILOID HV; weight-average molecular weight Mw: about 100,000) was prepared as a water-soluble polymer, which was dissolved in water in a concentration of 6% by weight to provide an aqueous solution. To 200 g of the resultant aqueous solution, 1.2 g of sodium dodecyl sulfate as an ionic surfactant (available from Wako Pure Chemical Industries, Ltd.; average particle size: 0.35 mm) and 2.3 g of glycerin as a plasticizer (available from Nacalai Tesque, Inc.) were added. The aqueous solution was agitated with a mixer to provide a foamed composition. The foamed composition was drawn into an A4-size sheet with a thickness of about 2 cm, which was then pre-frozen at −43° C. for 14 hours. Thereafter, the foamed frozen product was dried at a drying temperature of 10° C. and a pressure of less than 10 Pa for 30 hours to produce a sound absorbing article (Example 1).

The sound absorbing article of Example 1 had an apparent density of 0.058 g/cm³ and an expansion ratio of about 15.9 times, and contained open cells similar to those shown in FIG. 1.

As shown in FIG. 2, the sound absorbing article of Example 1 had a higher sound absorption coefficient than that of the sound absorbing article of Comparative Example 2 in a frequency region of 1,300 Hz or more, which exhibited good sound-absorbing performance suitable for application to home electric appliances.

The sound absorbing article of Example 1 had a water dissolution time of about 10 minutes, showing sufficient water solubility.

### Example 2

A sound absorbing article (Example 2) was produced in the same manner as Example 1, except that the addition amount of the sodium dodecyl sulfate as the ionic surfactant was altered to 0.6 g.

The sound absorbing article of Example 2 had an apparent density of 0.064 g/cm³ and an expansion ratio of about 14.4 times, and contained open cells similar to those shown in FIG. 1.

As shown in FIG. 2, the sound absorbing article of Example 2 had a higher sound absorption coefficient than that of the sound absorbing article of Comparative Example 2 in a frequency region of 2,000 Hz or more, which exhibited good sound-absorbing performance suitable for application to home electric appliances. However, the sound absorbing article of Example 2 was slightly inferior in sound-absorbing performance to the sound absorbing article of Example 1.

The sound absorbing article of Example 2 had a water dissolution time of about 10 minutes, showing sufficient water solubility.

### Example 3

After the sound absorbing article produced in Example 1 was kept for one week under a load of 0.056 kg/cm², the sound absorbing article was recycled in the following manner. The sound absorbing article of Example 1 was dissolved in water to prepare an aqueous solution with a concentration of 5% by weight. The aqueous solution had a viscosity of 2.8×10³ (Pa·s). The aqueous solution was agitated with a mixer to provide a foamed composition.

The foamed composition was drawn into an A4-size sheet with a thickness of about 2 cm, which was then pre-frozen at −43° C. for 14 hours. Thereafter, the foamed frozen product was dried at a drying temperature of 10° C. and a pressure of less than 10 Pa for 30 hours to produce a sound absorbing article (Example 3).

The sound absorbing article of Example 3 had an apparent density of 0.055 g/cm³ and an expansion ratio of about 16.7 times, and contained open cells similar to those shown in FIG. 1.

As shown in FIG. 2, the sound absorbing article of Example 3 had a higher sound absorption coefficient than that of the sound absorbing article of Comparative Example 2 in a frequency region of 1,300 Hz or more, which exhibited good sound-absorbing performance suitable for application to home electric appliances.

The sound absorbing article of Example 3 had a water dissolution time of about 10 minutes, showing sufficient water solubility.

### Example 4

A sound absorbing article (Example 4) was produced in the same manner as Example 1, except that 1.2 g of N-lauroylsarcosine sodium salt (available from Nacalai Tesque, Inc.) was used as the ionic surfactant.

The sound absorbing article of Example 4 had an apparent density of 0.067 g/cm³ and an expansion ratio of about 13.7 times, and contained open cells similar to those shown in FIG. 1.

As shown in FIG. 2, the sound absorbing article of Example 4 had a higher sound absorption coefficient than that of the sound absorbing article of Comparative Example 2 in a frequency region of 1,150 Hz or more, which exhibited good sound-absorbing performance suitable for application to home electric appliances.

The sound absorbing article of Example 4 had a water dissolution time of about 15 minutes, showing sufficient water solubility.

### Example 5

A sound absorbing article (Example 5) was produced in the same manner as Example 1, except that 1.2 g of laurylbetaine (available from Kao Corporation, Amphitol [registered trademark] 20BS) was used as the ionic surfactant.

The sound absorbing article of Example 5 had an apparent density of 0.070 g/cm³ and an expansion ratio of about 13.1 times, and contained open cells similar to those shown in FIG. 1.

As shown in FIG. 2, the sound absorbing article of Example 5 had a higher sound absorption coefficient than that of the sound absorbing article of Comparative Example 2 in a frequency region of 1,550 Hz or more, which exhibited good sound-absorbing performance suitable for application to home electric appliances.

The sound absorbing article of Example 5 had a water dissolution time of about 8 minutes, showing sufficient water solubility.

### Example 6

Propylene glycol alginate (available from KIMIKA corporation, KIMILOID HV; weight-average molecular weight Mw: about 100,000) was prepared as a first water-soluble polymer, which was dissolved in water in a concentration of 6% by weight to provide a first aqueous solution. Carboxymethyl cellulose sodium salt (available from Nacalai Tesque, Inc.) was prepared as a second water-soluble polymer, which was dissolved in a concentration of 5% by weight in water to provide a second aqueous solution. The first and second solutions were mixed to adjust a ratio by weight of the propylene glycol alginate and carboxymethyl cellulose sodium salt to 1:1 to prepare a mixed aqueous solution. A sound absorbing article (Example 6) was produced in the same manner as Example 1, except that 200 g of the resultant mixed aqueous solution was used.

The sound absorbing article of Example 6 had an apparent density of 0.050 g/cm³ and an expansion ratio of about 19.4 times, and contained open cells similar to those shown in FIG. 1.

As shown in FIG. 2, the sound absorbing article of Example 6 had a higher sound absorption coefficient than that of the sound absorbing article of Comparative Example 2 in a frequency region of 1,150 Hz or more, which exhibited good sound-absorbing performance suitable for application to home electric appliances.

The sound absorbing article of Example 6 had a water dissolution time of about 10 minutes, showing sufficient water solubility.

### Comparative Examples 1 and 2

Sound absorbing articles made of soft polyurethane foams were produced in the following manner.

The following components were mixed to prepare a polymer composition.

Glycerin monoacrylate (A1-1): 3 parts;

Polyol (A2-3) prepared by adding PO (73 mol) to glycerin (1 mol) and further adding EO (16 mol): 60 parts;

Polymer polyol (A2-4) prepared by polymerizing acrylonitrile in (A2-3), containing polyacrylonitrile 20% by weight: 40 parts;

Diethanolamine: 1 part;

Silicone-based foam stabilizing agent (available from Toray Silicone Co., Ltd., Silicone SRX-253) 1 part;

Water: 3.7 parts;

Triethylenediamine-based amine catalyst (available from Tosoh Corporation, TEDA L33) 0.4 parts; and

Bis(dimethylaminoethyl) ether-based amine catalyst (available from Tosoh Corporation, TOYOCATET): 0.07 parts.

The polymer composition was temperature-controlled at 25° C., to which 50.4 parts of an isocyanate mixture (NCO index 100) of TDI/crude MDI (80% by weight/20% by weight), temperature-controlled at 25° C., was added and stirred at 4000 rpm for 10 seconds with an agitator (Homodisper, manufactured by Tokushu Kika Kogyo Co., Ltd.) to provide a foamed composition. An aluminum mold with a size of 300 mm-length×300 mm-width×100 mm-height was temperature-controlled at 60° C., to which the foamed composition was injected. After 10 minutes, a product was released from the mold to provide soft polyurethane foam.

Among the soft polyurethane foams produced in the aforementioned manner, one having an apparent density of 0.022 g/cm³ was designated as the sound absorbing article of Comparative Example 1 and one having an apparent density of 0.060 g/cm³ was designated as the sound absorbing article of Comparative Example 2.

FIG. 2 shows that, in some cases, the sound absorbing articles of Comparative Examples 1 and 2 exhibited higher sound-absorbing performance in a frequency region of 1000 Hz or less. However, it was found that they had lower sound-absorbing performance than those of the sound absorbing articles of Examples 1 to 6 in a frequency region of 1000 Hz or more and thus they were unsuitable for application to home electric appliances.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sound absorbing article, comprising:
a water-soluble foamed matrix comprising a water-soluble polymer and an ionic surfactant, wherein an open cell is formed in the foamed matrix.

2. The article according to claim 1, wherein the open cell forms continuous layered open cells.

3. The article according to claim 1, wherein the water-soluble polymer is selected from the group consisting of alginic acid, alginic acid salts, and alginic acid derivatives.

4. The article according to claim 3, wherein the water-soluble polymer has a weight-average molecular weight from 70,000 to 100,000.

5. The article according to claim 1, wherein the water-soluble polymer is a mixture of two or more types of water-soluble polymers.

6. The article according to claim 1, wherein the ionic surfactant is contained at a ratio of 1 to 10% by weight.

7. The article according to claim 1, wherein the ionic surfactant is cationic, anionic or amphoteric.

8. The material according to claim 1, further comprising a plasticizer.

9. The article according to claim 1, wherein the plasticizer is contained at a ratio of 10 to 30% by weight.

10. A method of producing a sound absorbing article, comprising:
preparing an aqueous solution comprising a water-soluble polymer and an ionic surfactant;
foaming the aqueous solution to provide a foamed composition;
freezing the foamed composition to form a foamed frozen product; and
drying the foamed frozen product to produce a sound absorbing article.

11. The method according to claim 10, wherein the water-soluble polymer is selected from the group consisting of alginic acid, alginic acid salts, and alginic acid derivatives.

12. The method according to claim 11, wherein the water-soluble polymer has a weight-average molecular weight from 70,000 to 100,000.

13. The method according to claim 10, wherein the water-soluble polymer is a mixture of two or more types of water-soluble polymers.

14. The method according to claim 10, wherein the ionic surfactant is contained in the formed composition at a ratio of 1 to 10% by weight.

15. The method according to claim 10, wherein the ionic surfactant is cationic, anionic or amphoteric.

16. The method according to claim 10, wherein the formed composition further comprises a plasticizer.

17. The method according to claim 10, wherein the plasticizer is contained in the formed composition at a ratio of 10 to 30% by weight.

18. A method of recycling a sound absorbing article, comprising:
dissolving the sound absorbing article according to claim 1 in water to prepare an aqueous solution comprising a water-soluble polymer and an ionic surfactant;
foaming the aqueous solution to provide a foamed composition;
freezing the foamed composition to form a foamed frozen product; and
drying the foamed frozen product to produce a recycled sound absorbing article.
